(19) United States
(12) Patent Application Publication
(10) Pub. No.: US 2015/0157043 A1
(43) Pub. Date: Jun. 11, 2015

(54) EDIBLE FOOD CONTAINER FOR NONHUMAN ANIMALS

(71) Applicant: Gregory Martin, Blue Ridge, GA (US)

(72) Inventor: Gregory Martin, Blue Ridge, GA (US)

(21) Appl. No.: 14/098,629

(22) Filed: Dec. 6, 2013

(51) Int. Cl. A23K 1/00; A23K 1/16; A23K 3/00

(52) U.S. Cl. CPC A23K 1/003; A23K 1/00; A23K 3/00; A23K 1/1603; A23K 1/004

(57) ABSTRACT

Implementations of an edible dog food bowl and the method of manufacture thereof are provided. In some implementations, the edible container, or bowl, has a waffle grid like pattern about both its exterior and interior surfaces. The bowl may be manufactured from a batter, which generally comprised of rice flower, honey, whole eggs, butter, vanilla extract, garlic powder, salmon oil and cinnamon.

### TECHNICAL FIELD

This disclosure relates to implementations of edible food containers for nonhuman animals.

### BACKGROUND

A typical food container for a nonhuman animal, or pet, is manufactured from a material which is not suitable for consumption. These containers are frequently manufactured from a synthetic material or metal. As a result of being non-consumable, the container must be regularly cleaned in order to prevent the buildup of unhealthy bacteria. Such containers may also pose a health risk to nonhuman animals which chew on the food container.

Attempts to address the aforementioned problems have been made by creating edible food containers for nonhuman animals. For example, U.S. Pat. No. 5,346,710 to Geitner (“'710 patent”) discloses an edible food container formed from material suitable for tarter control such as is found in dog or cat biscuits. The disadvantage to the use of such material is that dog and cat biscuit material is not nutritionally sound and contains a variety of fillers and other sources of unnecessary calories. Further, dog and cat biscuit material generally contains gluten and other unnecessary starches. These nutritionally deficient materials may lead to obesity and other health conditions.

As another example, U.S. Patent Application Publication No. 2007/0234965 to Aguilar et al. (“'965 patent application”) discloses an edible food container made from a material(s) to provide “extending chewing”. Such a chewy container would be difficult for some animals to finish, eating thereby leaving an untidy mess behind for the owner to clean up. Such an edible food container may also be difficult for some nonhuman animals to digest.

### BRIEF DESCRIPTION OF THE DRAWINGS

FIG. 1 illustrates an implementation of an edible food container in accordance with the present invention.

### DETAILED DESCRIPTION

Implementations of a edible dog food container and the method of manufacture thereof are provided, in some implementations, the edible food container, or bowl, has a waffle grid like pattern about both its exterior and interior surfaces. The edible food container may be manufactured from a batter, which is generally comprised of rice flower, honey, whole eggs, butter, vanilla extract, garlic powder, salmon oil and cinnamon.

In other implementations, vitamins from the B and D complex are added to the aforementioned batter.

In still other implementations, sucrose is substituted in place of honey in the batter.

In some implementations, a spray on flavoring is added to the the edible food container. The flavorings include, but are not limited to, cheese, peanut butter and bacon.

In some implementations, a slot is formed in the bottom of the edible food container to receive medications which may come in solid form, a pill, powder, or capsule for example.

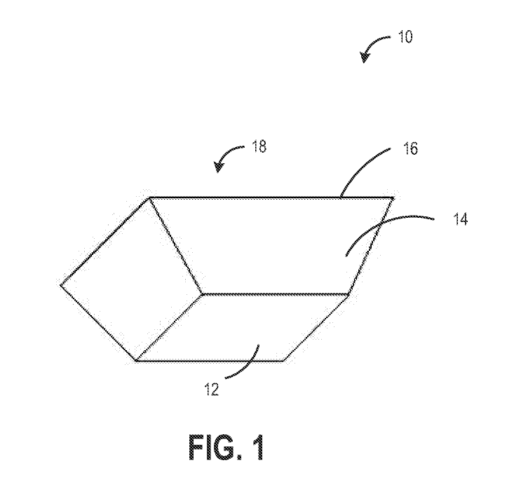

FIG. 1 illustrates an implementation of an edible food container 10 according to the present disclosure. The edible food container 10, or bowl, has a bottom 12, walls 14 and an annular rim 16 which together form an interior opening 18. The interior opening 18 is shaped to receive nonhuman animal food therein.

In some implementations, the interior and/or exterior of the walls 14 and/or the bottom 12 can have a waffle grid like texture. In some implementations, the walls 14 and bottom 12 have no texture.

In some implementations, the opening 18 increases in diameter from the bottom 12 to the top 16 of the container 10. In this way, a plurality of container 10 may be stackable. In other implementations, the size of the opening 18 from the bottom to the top of the container 10 is constant.

In some implementations, the edible food container 10 illustrated in FIG. 1 may be manufactured from a material, or batter, that is generally comprised of at least the following components: rice flower, honey, whole chicken eggs, butter, vanilla extract, garlic powder, salmon oil and cinnamon. Rice can be used because it is a naturally gluten free grain. Garlic powder may be a natural appetite stimulate for dogs. In some implementations, sucrose, or table sugar, can be used in place of honey. In some implementations, salmon oil, cinnamon, vanilla extract, garlic powder, or a combination thereof can be omitted.

Table 1 shows an example composition of the batter for some implementations of the edible bowl 10. The batter may be comprised of the following ingredients in their preferred amounts by a volume percent basis:

TABLE 1

| | Range | Preferred Range |
|---|---|---|
| Components | (Volume % basis) | (Volume % basis) |
| Rice Flour | 35%-41% | 37%-39% |
| Honey or Sucrose | 16%-22% | 18%-20% |
| Whole Eggs | 7%-8% | 7.2%-7.8% |
| Butter | 16%-22% | 18%-20% |
| Vanilla Extract | 2.1%-2.6% | 2.3%-2.4% |
| Garlic Powder | 6.7%-7.5% | 6.9%-7.3% |
| Salmon Oil | 2.1%-2.6% | 2.3%-2.4% |
| Cinnamon | 4.4%-5.1% | 4.6%-4.9% |

In some implementations, the batter used to manufacture the bowl 10 includes D and B complex vitamins, in some implementations, the B complex vitamins include any one, or combination, of B₁, B₂, B₃, B₅, B₆, B₇, B₉, and B₁₂ vitamins.

In some implementations, the edible container 10 has an additional flavoring added. Examples of flavoring include peanut butter, cheese, and bacon.

In some implementations, the batter used to manufacture the bowl 10 may be further comprised of an ingestible external parasite repellent which targets fleas and/or ticks. In some implementations, an ingestible internal parasite treatment for heart worms may also be added. In some implementations, a bowl 10 manufactured from such a batter composition (i.e., an ingestible external parasite repellent, an ingestible internal parasite treatment for heart worms, or any other non-food additive) may be dyed a differentiating color to visually distinguish it from other implementations which lack such additive. Example colors include, but are not limited to, red and green.

In some implementations, the edible container 10 may be manufactured to absorb and dilute medications. This allows the edible container 10 to serves as a vehicle to medicate the nonhuman animal that eats the bowl 10.

In some implementations, due to the composition of the batter, the edible container 10 may absorb the flavor of many food types placed within the interior 18 opening. This has the potential to make eating the bowl 10 more desirable to the nonhuman animal.

The exact shape and size of the edible container 10 along with the texture of the walls 14 may be varied without departing from the scope of the invention disclosed herein. For example, the shape of the edible container 10 can be trapezoidal as shown in FIG. 1 or cylindrical, semi-circular, or any suitable shape.

The size of the edible container 10 and thereby its interior opening 18 can vary based on the size of the nonhuman animal being fed and the corresponding volume of food intended be contained therein.

An example method of manufacturing the edible container 10 comprises mixing the components of the batter disclosed in Table 1, under “Preferred Range”, in a conventional bowl of appropriate size and pouring an apportioned amount of the mixture into a heated waffle iron. During this initial cooking phase, the batter is heated until it is a flexible-solid. Also, during this initial cooking phase, the waffle grid pattern is formed on the container 10.

In some implementations, the cooked batter then can be placed within a bowl shaped mold and left to cool. Once fully cooled, the cooked batter has now taken on the shape of the edible container 10 shown in FIG. 1.

In some implementations, flavoring can be sprayed onto the exterior of the edible container 10 after it is cooked.

In some implementations of the manufacturing process, a cooking iron, or similar device, without a waffle pattern is used.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. An edible food container for a nonhuman animal comprised of:
a food container having a bottom and one or more side walls extending therefrom, the combination of said bottom and one or more side walls forming an interior cavity configured to hold nonhuman animal food, said food container comprising of a batter generally comprised, of:
rice flour;
a sweetener, wherein said sweetener is selected from either sucrose or honey;
eggs;
butter; and
at least one member of a group consisting of vanilla extract; garlic powder; salmon oil; and cinnamon.

2. The edible food container of claim 1, wherein said batter is further comprised, of at least one member of a group consisting of B complex vitamins and D complex vitamins.

3. The edible food container of claim 1, wherein said batter is further comprised of an ingestible external parasite repellant.

4. The edible food container of claim 1, wherein said batter is further comprised of an ingestible internal parasite treatment.

5. The edible food container of claim 3, further comprising a first color wherein the first color is different than a color of an edible food container that does not include an ingestible external parasite repellant.

6. The edible food container of claim 4, further comprising a first color wherein the first color is different than a color of an edible food container that does not include an ingestible internal parasite treatment.

7. The edible food container of claim 1, further comprising a flavoring coating.

8. The edible food container of claim 7, wherein said flavoring coating is comprised of at least one of a group consisting of bacon flavoring, cheese flavoring, and peanut butter flavoring.

9. An edible food container for a nonhuman animal comprised, of:
a food container having a bottom and one or more side walls extending therefrom, the combination of said bottom and one or more side walls forming an interior cavity configured to hold nonhuman animal food, said food container comprising of a batter generally comprised of:
at least 35%-41% volume percent of rice flour;
16%-22% volume percent of sweetener, wherein said sweetener is selected from either sucrose or honey;
7%-8% volume percent of eggs;
16%-22% volume percent of butter; and
at least one member of a group consisting of at least 2.1%-2.6% volume percent of vanilla extract; 6.7%-7.5% volume percent of garlic powder, less than 2.6% volume percent of salmon oil; and 4.4%-5.1% volume percent of cinnamon.

10. The edible food container of claim 9, wherein said batter is further comprised of at least one member of a group consisting of B complex vitamins and D complex vitamins.

11. The edible food container of claim 9, wherein said batter is further comprised of an ingestible external parasite repellant.

12. The edible food container of claim 9, wherein said batter is further comprised of an ingestible internal parasite treatment.

13. The edible food container of claim 11, further comprising a first color wherein the first color is different than a color of an edible food container that does not include an ingestible external parasite repellant.

14. The edible food container of claim 12, further comprising a first color wherein the first color is different than a color of an edible food container that does not include an ingestible internal parasite treatment.

15. The edible food container of claim 9, further comprising a flavoring coating.

16. The edible food container of claim 15, wherein said flavoring coating is comprised of at least one of a group consisting of bacon flavoring, cheese flavoring and peanut butter flavoring.

17. The edible food container of claim 9, wherein the bottom includes a pocket to receive medication.

18. A method of manufacturing the edible food container of claim 9:
placing said batter to a cooking device;
cooking said batter in said cooking device until it is a flexible-solid;
removing said batter from said cooking device and placing said batter into a mold; and
allowing said batter to cool while in said mold, thereby forming an edible food container.

19. The method of claim 18, wherein said cooking device is a waffle iron.

20. The method of claim 18, further comprising the step of coating said edible food container with a flavoring, said flavoring comprised of at least one of a group consisting of bacon flavoring, cheese flavoring and peanut butter flavoring.
